(19) United States
(12) Patent Application Publication
(10) Pub. No.: US 2010/0193263 A1
(43) Pub. Date: Aug. 5, 2010

(54) TRACTION APPARATUS TO IMPROVE WINTER OPERATION OF RUBBER TRACKS ON ENDLESS TRACK VEHICLES

(76) Inventors: Gordon Kaiser, Fairview (CA); Dave Whitney, Fairview (CA)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(21) Appl. No.: 12/686,282

(22) Filed: Jan. 12, 2010

(30) Foreign Application Priority Data
Jan. 30, 2009 (CA) 2651624

(51) Int. Cl. B62D 55/26; B62D 55/00

(52) U.S. Cl. 180/9.42; 305/15

(57) ABSTRACT

A traction apparatus to improve the winter operation of rubber tracks on endless track vehicle. A plurality of chains are provided each having a first end and a second end separated by multiple chain links. The chains are secured to the track at only the first end with the second end free. In operation the chains lay along the track to provide needed traction

### FIELD

Traction apparatuses to improve the winter operation of rubber tracks on endless track vehicles.

### BACKGROUND

Endless rubber track-driven vehicles are typically used in all-terrain or adverse terrain conditions, such as in mud, snow, and ice. Rubber tracks on such vehicles can lose traction in frozen or slippery surfaces such as ice causing them to slid, or become stuck. This is because the lugs on rubber tracks are not effective on frozen ground due to their inability to significantly penetrate the ground to gain traction.

### SUMMARY

According to one aspect there is provided a traction apparatus to improve the winter operation of rubber tracks on endless track vehicles. The traction apparatus includes a length of linked chain having an anchoring end and a free end which moves freely. An anchoring fixture is positioned at the anchoring end.

According to another aspect there is provided a combination which includes a track vehicle having an endless track mounted to propel the vehicle forward with chains secured to the track at only a first end with a second end free.

As will hereinafter be further explained, the combination will function better when the chain is secured to the track with an anchoring fixture, for the anchoring fixture prevents the chain from damaging the track.

As will hereinafter be further explained, the combination will function better when the anchoring fixture has an anchor link for joining the first end of each of the plurality of chains to the anchoring fixture and at least one recessed opening for receiving a bolt for securing the anchoring fixture to the endless track of the track vehicle. The anchor link helps orient the chain so it is not on edge.

As will hereinafter be further explained, the combination will function better when the endless track has a plurality of lugs with a transverse groove positioned between each lug, and each anchoring fixture is positioned in one of the transverse groove between lugs.

As will hereinafter be further explained, the combination will function between when each of the multiple chain links has at least one surface engaging projection. There surface engaging projections are readily available by purchasing tire chains.

### BRIEF DESCRIPTION OF THE DRAWINGS

These and other features will become more apparent from the following description in which reference is made to the appended drawings, the drawings are for the purpose of illustration only and are not intended to in any way limit the scope of the invention to the particular embodiment or embodiments shown, wherein:

FIG. 1 is a perspective top view of apparatus to improve the winter operation of rubber tracks installed on an endless rubber track according to the invention.

FIG. 2 is a perspective side elevation view of the apparatus,

FIG. 3 is a top plan view of the apparatus,

FIG. 4 is a perspective view of the apparatus.

### DETAILED DESCRIPTION OF THE PREFERRED EMBODIMENT

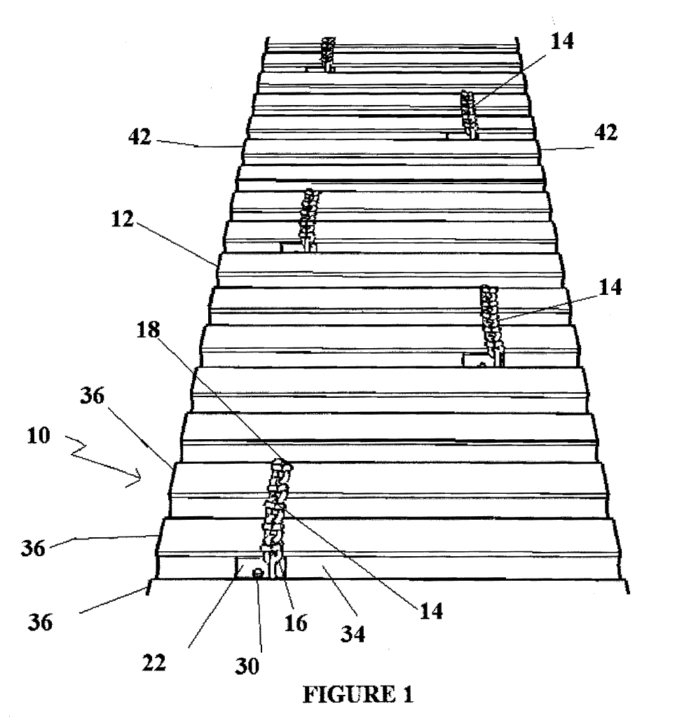

The preferred embodiment, an apparatus to improve the winter operation of rubber tracks, generally identified by reference numeral 10, will now be described with reference to FIGS. 1 through 4.

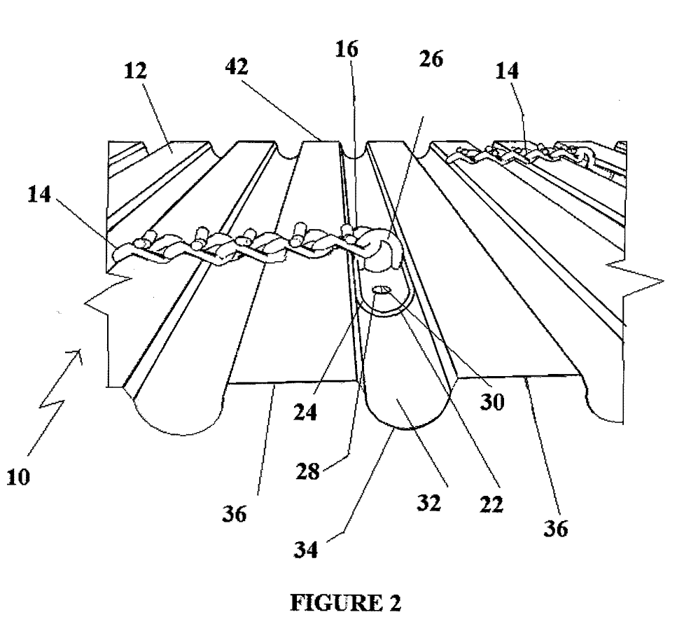

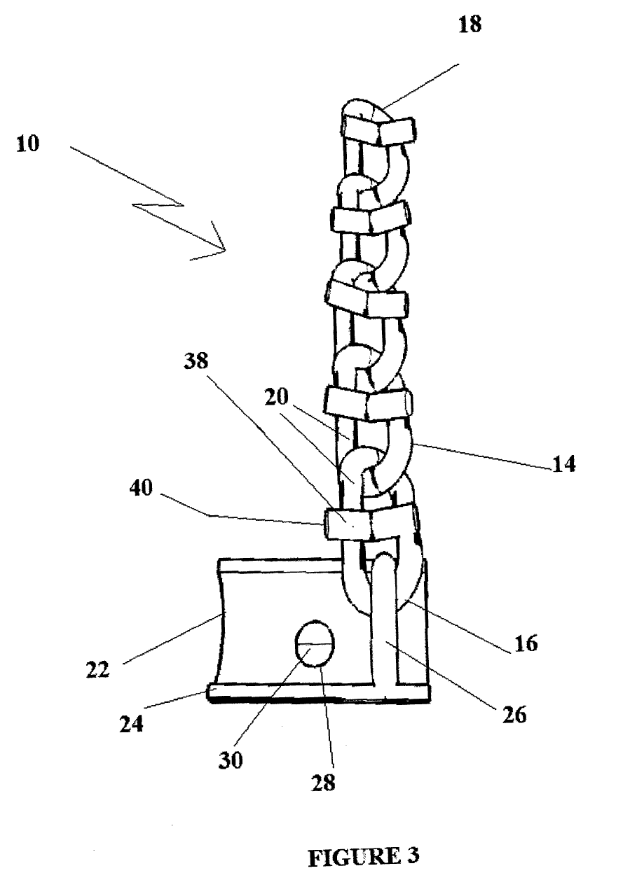

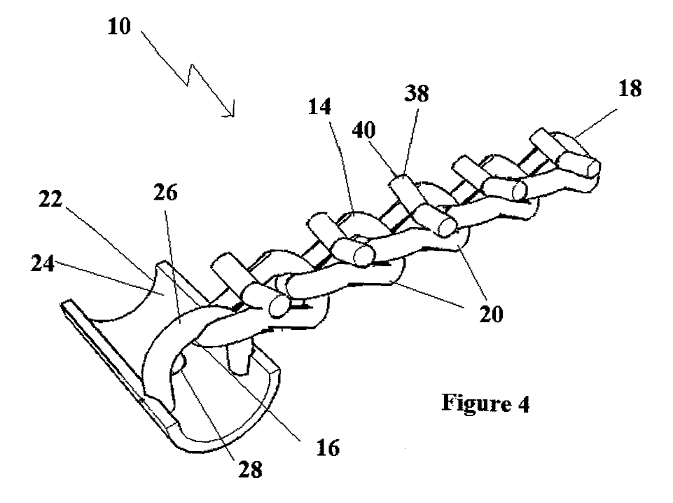

Referring to FIG. 1, there is illustrated a traction apparatus for an endless track vehicle, generally referenced by numeral 10 and a rubber track 12 for an endless track vehicle. Referring to FIGS. 3 and 4, traction apparatus 10 includes a plurality of chains 14 which each have a first end 16 and a second end 18 separated by multiple interconnected chain links 20. Referring to FIG. 2, each of chains 14 are secured to the track 12 at only first end 16 by an anchoring fixture 22. Second end 18 of chains 14 are unattached and move freely.

Referring to FIG. 4, in the illustrated embodiment, anchoring fixture 22 has a concave body 24 that defines a recess in which is positioned an anchor link 26 for joining first end 16 of each of chains 14 to concave body 24. It will be appreciated that the shape of anchoring fixture 22 is selected to fit transverse grooves in the track and there are other shapes and configuration of anchoring fixtures 22 which may be used to accommodate transverse groove configurations in other types of track. Anchor link 26 is positioned transverse to concave body 24. Referring to FIG. 3, a recessed opening 28 is also provided in concave body 24 for receiving a bolt 30 to secure anchoring fixture 22 to track 12. There may be more than one recessed opening 28 on either side of anchor link 26 as shown in FIG. 3, or only on one side as shown in FIG. 4. Referring to FIG. 2, concave body 24 is shaped to fit flush with a curved inner wall 32 of a transverse groove 34 between lugs 36 provided on track 12 so that each chain 14 extends substantially perpendicular to transverse groove 34. As will hereinafter described, in some installations a two bolt configuration is preferred.

Referring to FIG. 4, each of multiple chain links 20 has two surface engaging projections 38 that terminate in sharp points 40.

Operation:

Referring to FIG. 1, traction apparatus 10 improves winter operation of rubber tracks 12 for endless track vehicles when travelling on icy or frozen surfaces. As track 12 propels endless vehicle forward, chains 14 lay along with track 12. Chains 14 extend perpendicular to groove 34 in track 12 with second end 18 being permitted to move freely. Sharp points 40 of surface engaging projections 38 bite into an underlying icy or frozen surface to engage that surface and maintain traction. In the illustrated embodiment, chains 14 are spaced apart on alternating sides 42 of track 12 to ensure even traction, although it will be appreciated that there are other spacing relationships that would also work.

As chains 14 are only secured at first end 16 to track 10, chains 14 are less likely to catch debris such as branches and bushes as track 12 travels over them. As a result there is reduced chance that debris to be dragged along with track 12, and moreover, less likelihood that chains 14 will catch on something and break. By positioning anchoring fixture 22 within groove 34, there is less wear on rubber track 12 by movement of chains 14.

Cautionary Warnings

Based upon field experience, the following information will be of importance to anyone doing an installation on a vehicle track:

Anchoring Fixture: Initial installations were attempted by bolting chains directly to the track. This had the desired effect of increasing traction, but wear was noticed where the chain was attached to the bolt. By positioning an anchoring fixture in the transverse grooves, this wear was reduced, if not eliminated. The shape of the anchoring fixture will vary with the style of track. Some tracks have semi-circular grooves, for which concave anchoring fixtures work well. More recently tracks have been encountered that have flat bottom and sidewalls that converge inwardly toward the bottom. For those tracks, an anchoring fixture has been made that is flat at the bottom and has angled sidewalls that conform to the sidewalls of the groove.

Securing Anchoring Fixture: On initial tests with a small machine sold under the Trademark BOBCAT, a single bolt was used to secure the anchoring fixture to the track. When tests were subsequently performed on larger machines, there were failures due to snow getting under the anchoring fixture. This problem was solved by using two bolts, one on either side of the anchoring fixture.

Anchor link: On initial tests with a small machine sold under the Trademark BOBCAT, the chain sometimes was positioned on edge. That was acceptable when standard chain was used, but undesirable when tire chains were used which had surface engaging projections. In such cases, the surface engaging projections were to be oriented away from the track for maximum effectiveness. This was solved by using an anchor link positioned transverse to the anchoring fixture or, expressed another way, transverse to the groove and parallel to the direction of travel. No problems were experienced with the anchor link during tests with the BOBCAT. When tests were subsequently performed on larger machines, the anchor links began to break off. This problem was solved by ensuring that the anchor link was even with or below the height of the lugs.

Length of Chain: On initial tests with a small machine sold under the Trademark BOBCAT, it was determined that if the chains positioned on the track close to the cab were too long they would strike the machine, damaging the fender and hoses. For the BOBCAT, inside chains 3 to four inches in length and outside chains 8 to 12 inches in length worked well. It was initially believed that with a larger machine, longer chains would be required. It is now believed that a standard length of 3 to 4 inches in length is adequate. There are two reasons for this. The first reason is that the added length of chain does not appear to significantly increase traction. The second reason is that it is more cost effective and simplifies installation if a standard length is used.

Type of Chain: A standard chain will improve traction. However, better results can be obtained through the use of a tire chain having surface engaging projections. Such tire chains are readily available commercially. Beneficial results have been obtained through the use of tire chains sold the names V-BAR and TRIG. The V-BAR chain has a “V” configuration. The TRIG chain has a series of rounded or ball-like projections. It must be remembered that when a tire chain is used, it will have an orientation. During installation, you will want to ensure that attention is paid to the direction of travel of the track when the vehicle is moving forward. The chain will lay against the track as the vehicle moves forward and one should ensure that the surface engaging projections are extending outwardly away from the track, rather than against the track. It will be noted, that when the vehicle is driven in reverse, the surface engaging projections will rest against the track. This is acceptable on most track vehicles, as the proportion of time operated in reverse is relatively small.

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

It will be apparent to one skilled in the art that modifications may be made to the illustrated embodiment without departing from the spirit and scope of the invention as hereinafter defined in the Claims.

What is claimed is:

1. A traction apparatus for an endless track vehicle, comprising:
a length of linked chain having an anchoring end and a free end which moves freely; and
an anchoring fixture positioned at the anchoring end.

2. The traction apparatus of claim 1, wherein the anchoring fixture has an anchor link for joining the anchoring end of the length of linked chain to the anchoring fixture, and at least one recessed opening for receiving a bolt for securing the anchoring fixture to a track of an endless track vehicle.

3. The traction apparatus of claim 1, wherein the anchoring fixture has a recess in which the anchor link is positioned.

4. The traction apparatus of claim 1, wherein the length of linked chain is comprised of a series of interconnected links, each link having at least one surface engaging projection.

5. A combination, comprising:
a track vehicle having an endless track mounted to propel the vehicle forward; and
a plurality of chains having a first end and a second end separated by multiple chain links, each of the chains being secured to the track at only the first end with the second end free.

6. The combination as defined in claim 5 wherein the first end of each of the plurality of chains is secured to the track by an anchoring fixture.

7. The combination as defined in claim 5, wherein the anchoring fixture has an anchor link for joining the first end of each of the plurality of chains to the concave body and at least one recessed opening for receiving a bolt for securing the anchoring fixture to the endless track of the track vehicle.

8. The combination as defined in claim 7, wherein the endless track has a plurality of lugs with a transverse groove positioned between each lug, each anchoring fixture being positioned in one of the transverse groove between lugs.

9. The combination as defined in claim 5, wherein each of the multiple chain links has at least one surface engaging projection.

10. The combination as defined in claim 5, wherein the at least one surface engaging projection terminates in a sharp point.
